(19) United States
(12) Patent Application Publication
(10) Pub. No.: US 2024/0238149 A1
(43) Pub. Date: Jul. 18, 2024

(54) MOTION ASSISTANCE APPARATUS INCLUDING LINK HAVING FASTENING NOTIFICATION FUNCTION

(71) Applicant: Samsung Electronics Co., Ltd., Suwon-si (KR)

(72) Inventors: Younggwon KOO, Suwon-si (KR); Kuemjong BAE, Suwon-si (KR); Jihyeon YUN, Suwon-si (KR)

(21) Appl. No.: 18/619,888

(22) Filed: Mar. 28, 2024

Related U.S. Application Data
(63) Continuation of application No. PCT/KR2023/014124, filed on Sep. 19, 2023.

(30) Foreign Application Priority Data
Sep. 20, 2022 (KR) 10-2022-0118859
Oct. 21, 2022 (KR) 10-2022-0136442
Dec. 16, 2022 (KR) 10-2022-0177417
Sep. 15, 2023 (KR) 10-2023-0123106

(51) Int. Cl. A61H 3/00; A61H 1/02

(52) U.S. Cl. CPC A61H 3/00; A61H 1/0244; A61H 2003/007; A61H 2201/1215; A61H 2201/149; A61H 2201/163; A61H 2201/1635; A61H 2201/1642; A61H 2201/1652; A61H 2201/169

(57) ABSTRACT

A motion assistance apparatus may include a link having a fastening notification function. The motion assistance apparatus may include a waist frame and a waist belt worn around a waist of a user, a force transmission frame and a thigh belt worn around a thigh of the user, an actuator connected to the waist frame and configured to generate power, an upper frame connected to the actuator, a lower frame connected to the upper frame and configured to transmit the generated power to the force transmission frame, the link connecting the upper frame to the lower frame.

### CROSS-REFERENCE TO RELATED APPLICATIONS

This application is a continuation application of International Application No. PCT/KR2023/014124 designating the United States, filed on Sep. 19, 2023, in the Korean Intellectual Property Receiving Office and claims the benefit of Korean Patent Application No. 10-2022-0118859 filed on Sep. 20, 2022, Korean Patent Application No. 10-2022-0136442 filed on Oct. 21, 2022, Korean Patent Application No. 10-2022-0177417 filed on Dec. 16, 2022, and Korean Patent Application No. 10-2023-0123106 filed on Sep. 15, 2023, in the Korean Intellectual Property Office, the entire disclosures of which are all hereby incorporated herein by reference in their entireties.

### BACKGROUND

### 1. Field

One or more example embodiments relate to a motion assistance apparatus including a link having a fastening notification function.

### 2. Description of the Related Art

In a rapidly aging society, a growing number of people has experienced inconvenience and pain from joint problems and interest in an assist device for assisting elderly users and patients in walking with ease, and/or for assisting any users with exercise and/or walking, has been heightened. A motion assist apparatus, for an arm(s) and/or leg(s) of a user, may also be worn to strengthen muscular strength of a certain body part(s).

### SUMMARY

According to an example embodiment, there is provided a motion assistance apparatus including a link having a fastening notification function including a waist frame and a waist belt worn around a waist of a user, a force transmission frame and a thigh belt worn around a thigh of the user, an actuator connected, directly or indirectly, to the waist frame and configured to generate power, an upper frame connected, directly or indirectly, to the actuator, a lower frame connected, directly or indirectly, to the upper frame and configured to transmit the generated power to the force transmission frame, and the link connecting the upper frame to the lower frame.

The link, in an example embodiment, may include a link body disposed on, directly or indirectly, the lower frame, a main screw connected, directly or indirectly, to the link body to be rotatable, an ascending and descending plate including a plate body rotatable with the main screw and a protrusion protruding from the plate body and provided to be movable along an axial direction of the main screw, a handle connected, directly or indirectly, to the main screw to be rotatable and configured to transmit power to the ascending and descending plate, an inner elastic body, comprising elastic material (e.g., rubber and/or polymer inclusive), provided between at least the main screw and the plate body, and a holder connected, directly or indirectly, to the main screw to be rotatable, provided to be movable along the axial direction of the main screw, and provided on an opposite side of the handle based on the link body.

The protrusion, in an example embodiment, may receive an elastic force from the inner elastic body and moves along the axial direction of the main screw to contact with the handle when the handle rotates with respect to the plate body in a state in which the holder is in contact with the lower frame.

According to an example embodiment, there is provided a motion assistance apparatus comprising a link having a fastening notification function including a waist frame and a waist belt worn around a waist of a user, a force transmission frame and a thigh belt worn around a thigh of the user, an actuator connected to the waist frame and configured to generate power, an upper frame connected to the actuator, a lower frame connected to the upper frame and configured to transmit the generated power can be used by the force transmission frame, and the link connecting the upper frame to at least the lower frame, wherein the link may include a link body disposed on the lower frame, a main screw comprises a screw body supported by the link body and connected to the link body to be rotatable, an inner elastic body supported by the screw body, an ascending and descending plate supported by the inner elastic body and configured to be rotatable with the main screw and to be movable along an axial direction of the main screw, a handle, comprising a handle plate body facing the ascending and descending plate and a handle protrusion protruding from the handle plate body towards the ascending and descending plate, and connected the main screw and configured to be rotatable and to transmit power to the ascending and descending plate, and a holder connected to the main screw and configured to be rotatable and to be movable in the axial direction of the main screw, wherein the ascending and descending plate receives an elastic force from the inner elastic body and moves along the axial direction of the main screw to contact with the handle protrusion when the handle rotates with respect to the ascending and descending plate in a state in which the holder is in contact with the lower frame.

### BRIEF DESCRIPTION OF THE DRAWINGS

These and/or other aspects, features, and advantages will become apparent and more readily appreciated from the following description of example embodiments, taken in conjunction with the accompanying drawings of which:

FIG. 1 is a perspective view illustrating a user wearing a motion assistance apparatus according to an example embodiment;

FIG. 2 is a front view illustrating an upper frame, a lower frame, and a link according to an example embodiment;

FIG. 3 is a perspective view illustrating a link and a lower frame according to an example embodiment;

FIG. 4 is a cross-sectional view illustrating the link and the lower frame according to an example embodiment;

FIG. 5 is another cross-sectional view illustrating the link and the lower frame according to an example embodiment;

FIG. 6 is a diagram illustrating a process of generating a fastening notification contact sound, according to an example embodiment;

FIG. 7 is a plan view illustrating a link body, a locking bar, and a handle according to an example embodiment; and

FIG. 8 is a bottom view illustrating the link body, the locking bar, the handle, and a pair of guide rails according to an example embodiment.

### DETAILED DESCRIPTION

The following detailed structural or functional description is provided as an example only and various alterations and modifications may be made to examples. Accordingly, the example embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The same name may be used to describe an element included in the example embodiments described above and an element having a common function. Unless otherwise mentioned, the descriptions of the example embodiments may be applicable to the following example embodiments and thus, duplicated descriptions will be omitted for conciseness.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the examples will be described in detail with reference to the accompanying drawings. When describing the embodiments with reference to the accompanying drawings, like reference numerals refer to like components and a repeated description related thereto will be omitted.

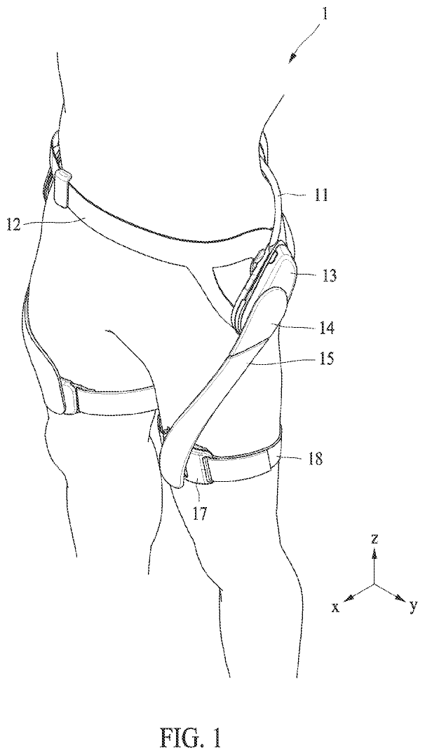

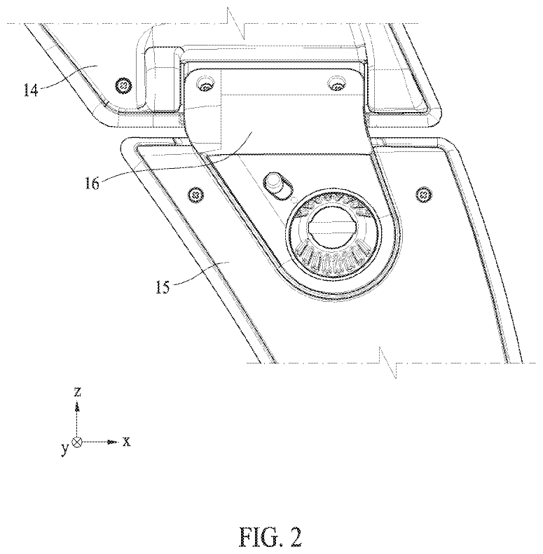

FIG. 1 is a perspective view illustrating a user wearing a motion assistance apparatus according to an embodiment and FIG. 2 is a front view illustrating an upper frame, a lower frame, and a link according to an embodiment.

Referring to FIGS. 1 and 2, according to an embodiment, a motion assistance apparatus 1 including a link having a fastening notification function (which may be referred to as a “motion assistance apparatus”) may be worn by a user and assist motion of the user. The user may be a human, a robot, and the like but is not limited thereto. The motion assistance apparatus 1 may assist motion of some upper or lower body joints of the user. For example, the motion assistance apparatus 1 may assist motion of the lower body of the user by assisting at least one of the hip joint, knee joint, and ankle joint of the user. The motion assistance apparatus 1 may include a waist wearing part, a thigh wearing part, an actuator 13, an upper frame 14, a lower frame 15, and a link 16.

In an embodiment, the waist wearing part and the thigh wearing part may be opposite to each other based on one body part of the user and respectively worn on a proximal part and a distal part of the user. For example, the waist wearing part may wrap around the waist and/or the pelvis and the thigh wearing part may wrap around the thighs, knees, calves, and/or feet.

In an embodiment, the waist wearing part may include a waist frame 11 wrapping around a part of the waist of the user and a waist belt 12 connected, directly or indirectly, to the waist frame 11 and wrapping around the remaining part of the waist of the user. For example, the waist frame 11 may wrap around the back of the waist and the waist belt 12 may wrap around the front of the waist.

In an embodiment, the thigh wearing part may include a force transmission frame 17 wrapping around a part of the thigh of the user and a thigh belt 18 connected, directly or indirectly, to the force transmission frame 17 and wrapping around the remaining part of the thigh of the user. For example, the force transmission frame 17 may cover the front of the thigh.

In an embodiment, the waist wearing part and the thigh wearing part may move relative to each other on a sagittal plane. For example, when the user flexes or extends the hip joint while wearing the motion assistance apparatus 1, the thigh belt 18 may rotate/pivot/move relative to the waist belt 11 on the sagittal plane.

In an embodiment, the waist wearing part and the thigh wearing part may move relative to each other on a frontal plane. For example, when the user adducts or abducts the hip joint while wearing the motion assistance apparatus 1, the thigh wearing part may rotate relative to the waist wearing part on the frontal plane.

In an embodiment, the lower frame 15 and the thigh wearing part may move relative to each other on a transverse plane. For example, when the user rotates the thigh while wearing the motion assistance apparatus 1, the thigh wearing part may rotate with the thigh while in close contact with the thigh. The force transmission frame 17 may rotate relative to the lower frame 15. In this structure, the wearability of the user may increase.

In an embodiment, the actuator 13 may connect to the waist frame 11 and generate power. The actuator 13 may include, for example, a motor and a speed reducer. The motor may include at least one of a brush motor, a brushless motor, and a stepping motor. The motor may include at least one of an induction motor and a synchronous motor. The speed reducer may include, for example, a gear train.

In an embodiment, the upper frame 14 and the lower frame 15 may transmit the power generated by the actuator 13 to the force transmission frame 17. For example, the upper frame 14 and the lower frame 15 may assist motion of the hip joint of the user. When an output terminal of the actuator 13 rotates in one direction, the upper frame 14 and the lower frame 15 may receive power from the actuator 13 and assist flexion motion of the hip joint of the user. When the output terminal of the actuator 13 rotates in an opposite direction to the one direction, the upper frame 14 and the lower frame 15 may receive power from the actuator 13 and assist extension motion of the hip joint of the user.

In an embodiment, the upper frame 14 maybe provided detachable from the actuator 13. For example, the upper frame 14 maybe coupled, directly or indirectly, to the outer surface of the actuator 13. The upper frame 14 maybe separated from the actuator 13 without disassembling the actuator 13.

In an embodiment, the lower frame 15 may connect to the upper frame 14 to be rotatable and connect, directly or indirectly, to the thigh belt 18. The lower frame 15 may cover some of the thigh part of the user.

According to an embodiment, the upper frame 14 and the lower frame 15 may be connected spaced apart from each other. The link 16 may be provided between at least the upper frame 14 and the lower frame 15 and may be connected, directly or indirectly, to rotate relative to the other frame.

In an embodiment, one frame may rotate relative to the other frame. For example, the lower frame 15, with respect to the upper frame 14, may rotate in a direction of adducting the hip joint of the user. When the user moves the thigh, only the lower frame 15 may rotate instead of the upper frame 14 and the lower frame 15 moving integrally. A movable range of the hip joint of the user on the frontal plane may increase. The thigh of the user may flexibly move. The wearability of the motion assistance apparatus 1 may increase.

In an embodiment, the user may suddenly move the thigh like the user falls while walking or walks on a steep slope. As the lower frame 15 rotates with respect to the upper frame 14 with the thigh, instantaneous force applied to the upper frame 14 may disperse. The flexion may not occur to the upper frame 14.

In an embodiment, one end of the link 16 may be connected, directly or indirectly, to a rotating shaft supported by the upper frame 14. The rotating shaft may connect the upper frame 14 to the link 16. In a state in which both ends of the rotating shaft are accommodated in a groove formed in the upper frame 14, the link 16 may rotate the rotating shaft as a rotating axis. The other end of the link 16 may be connected, directly or indirectly, to the lower frame 15. The lower frame 15 may rotate with respect to the upper frame 14.

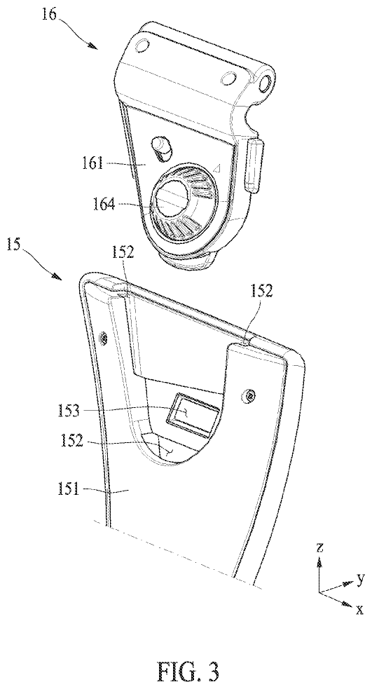

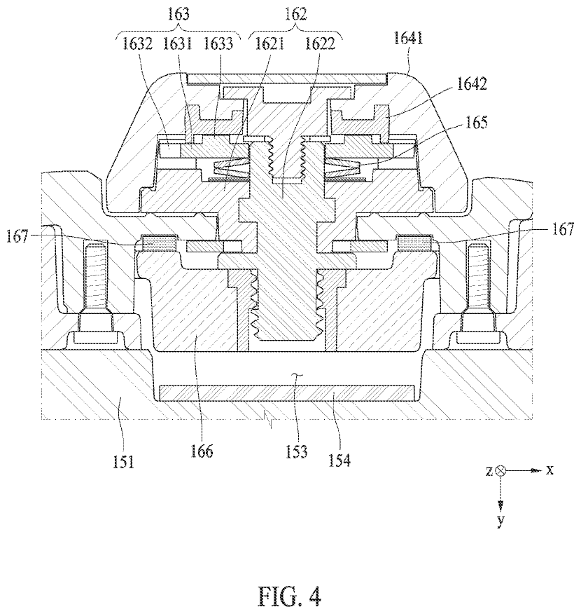

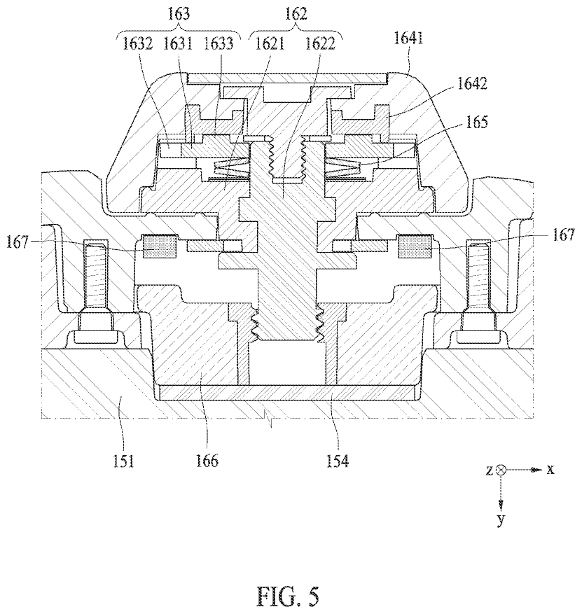

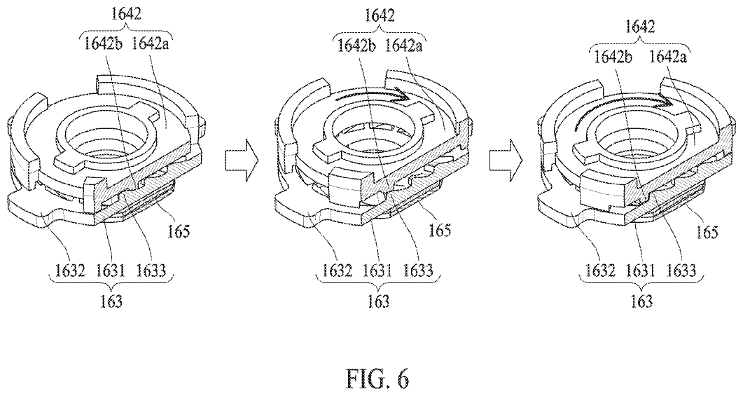

FIG. 3 is a perspective view illustrating a link and a lower frame according to an embodiment, FIG. 4 is a cross-sectional view illustrating the link and the lower frame according to an embodiment, FIG. 5 is another cross-sectional view illustrating the link and the lower frame according to an embodiment, and FIG. 6 is a diagram illustrating a process of generating a fastening notification contact sound, according to an embodiment.

Referring to FIGS. 3 to 6, according to an embodiment, a link body 161 may be connected, directly or indirectly, to the lower frame 15 to be detachable. The lower frame 15 may include a frame body 151 supporting the link body 161, a frame groove 152 recessed from the frame body 151, and a holder accommodating groove 153.

In an embodiment, the link body 161 may pass through the frame groove 152 and be disposed on, directly or indirectly, the lower frame 15. From this structure, in a state in which the link body 161 is disposed on the lower frame 15, movement of the link 16 relative to the lower frame 15 in x-axis and y-axis directions may be restricted. After the link body 161 is accommodated in the lower frame 15, a handle 164 may be rotated in a first direction. The handle 164 may rotate a main screw 162 in the same direction and a holder 166 may be accommodated in the holder accommodating groove 153. From this structure, movement of the link 16 relative to the lower frame 15 in the z-axis direction may be restricted and the link 16 may be connected, directly or indirectly, to the lower frame 15.

In an embodiment, the main screw 162 may be connected to the link body 161 to be rotatable. Here, the rotation axis of the main screw 162 may be parallel to the y-axis direction. The main screw 162 may include a screw body 1621 and a shaft 1622.

In an embodiment, the screw body 1621 may be supported by the link body 161. The shaft 1622 may pass through the center of the screw body 1621 and be fixed to the screw body 1621. Threads may be formed at one end of the shaft 1622. The holder 166 may be connected to the threads formed at one end of the shaft 1622.

In an embodiment, the holder 166 may be provided to be movable along the axial direction of the main screw 162 without rotating with respect to the lower frame 15. When the main screw 162 rotates in the first direction, the holder 166 may protrude from the link body 161 and come closer to the lower frame 15. A part of the holder 166 may be in the holder accommodating groove 153 and movement of the link 16 relative to the lower frame 15 in the z-axis direction may be restricted.

In an embodiment, in a state in which the main screw 162 continues to rotate in the first direction so that the bottom surface of the holder 166 contacts the lower frame 15 (which may be referred to as a “fastened state”), the holder 166 may not move even when the main screw 162 rotates in the first direction.

In an embodiment, when the main screw 162 rotates in a second direction opposite to the first direction, the holder 166 may move away from the lower frame 15. When the main screw 162 continues to rotate in the second direction, the holder 166 may not be in the holder accommodating groove 153 (which may be referred to as a “released state”). The movement of the link 16 relative to the lower frame 15 in the z-axis direction may not be restricted.

In an embodiment, friction may occur between the bottom surface of the holder 166 and the lower frame 15 due to repeated fastening of the link 16. By disposing a cushioning material 154 between at least the bottom surface of the holder 166 and the lower frame 15, damage or abrasion of the holder 166 and the lower frame 15 may be reduced. For example, the cushioning material 154 may be provided on the bottom surface of the holder 166 or in the holder accommodating groove 153.

In an embodiment, the main screw 162 may receive rotation power through the handle 164. The handle 164 may be provided on an opposite side of the holder 166 based on the link body 161 and connected to the main screw 162 to be rotatable. The handle 164 may include a handle cover 1641 and a handle plate 1642.

In an embodiment, the handle cover 1641 may be provided on the outer surface of the link body 161. The other end of the shaft 1622 may support the handle cover 1641 so that the handle cover 1641 does not separate from the link body 161. The handle 164 may be rotated in the first direction and the second direction with respect to the link body 161.

In an embodiment, the handle plate 1642 may be connected to the handle cover 1641 and may rotate with the handle cover 1641. The handle plate 1642 may include a handle plate body 1642a supported by the handle cover 1641 and a handle protrusion 1642b protruding from the handle plate body 1642a toward the main screw 162.

In an embodiment, the handle protrusion 1642b may be provided in plurality along the circumference of the rotation axis of the handle 164 around the rotation axis of the handle 164. The height of the handle protrusion 1642b protruding from the handle plate body 1642a may decrease toward the first direction. The handle protrusion 1642b may press an ascending and descending plate 163.

As above, the handle cover 1641 and the handle plate 1642 are described as individual configurations, but the structure of the handle 164 is not necessarily limited thereto. For example, in another embodiment, the handle plate 1642 may be integrally formed with the handle cover 1641. In another embodiment, the handle plate body 1642a may be integrally formed with the handle cover 1641.

In an embodiment, the ascending and descending plate 163 may rotate with the main screw 162 and provided to be movable along the axial direction of the main screw 162. An inner elastic body 165 may be provided between at least the ascending and descending plate 163 and the main screw 162.

In an embodiment, the inner elastic body 165 may press the ascending and descending plate 163 in a direction away from the main screw 162. For example, the inner elastic body 165 may be a plate spring through which the shaft 1622 may penetrate the center of the inner elastic body 165. However, the type of the inner elastic body 165 is not necessarily limited thereto. For example, the inner elastic body 165 may be a coil spring. The ascending and descending plate 163 may include a plate body 1631, a plate wing 1632, and a plate protrusion 1633.

In an embodiment, the plate body 1631 may be supported by the inner elastic body 165. The plate wing 1632 may protrude from the plate body 1631 and be connected to the screw body 1621. Rotation of the ascending and descending plate 163 relative to the screw body 1621 may be restricted.

In an embodiment, the plate protrusion 1633 may protrude from the plate body 1631 toward the handle 164. The plate protrusion 1633 may be provided in plurality along the circumference of the rotation axis around the rotation axis of the main screw 162. The plate protrusion 1633 may be pressed by the handle protrusion 1642b.

In an embodiment, the plate protrusion 1633 may include an inclined surface of which the height protruding from the plate body 1631 increases towards the first direction. Through this structure, when the handle 164 rotates in the first direction, the handle protrusion 1642b may press the ascending and descending plate 163 in a direction of the main screw 162.

For example, when the handle 164 rotates in the first direction, the inner elastic body 165 may be pressed by the ascending and descending plate 163 and the ascending and descending plate 163 may rotate with the main screw 162 in the first direction. The holder 166 may move in a direction closer to the lower frame 15.

For example, when the handle 164 rotates in the second direction, the inner elastic body 165 may not be pressed by the ascending and descending plate 163 and the ascending and descending plate 163 may rotate with the main screw 162 in the second direction. The holder 166 may move in a direction away from the lower frame 15.

In an embodiment, since the holder 166 is supported on the lower frame 15 when the link 16 is in a fastened state, the main screw 162 may no longer rotate in the first direction. In this state, when the handle 164 is rotated in the first direction, the handle protrusion 1642b may slide along an inclined surface of the plate protrusion 1633 in the first direction. While the handle protrusion 1642b slides along the inclined surface of the plate protrusion 1633 in the first direction, a distance between the ascending and descending plate 163 and the main screw 162 decreases and the degree to which the inner elastic body 165 deforms may increase.

In an embodiment, after the handle protrusion 1642b slides along the inclined surface of the plate protrusion 1633 in the first direction, as the deformed inner elastic body 165 presses the ascending and descending plate 163 in a direction of the handle 164, the plate body 1631 may contact the handle protrusion 1642b. When the plate body 1631 contacts the handle protrusion 1642b, a contact sound loud enough to be perceived by the user may be generated. The user may recognize that the link 16 is fastened to the lower frame 15 through the contact sound. Meanwhile, as the deformed inner elastic body 165 presses the ascending and descending plate 163 in the direction of the handle 164, the plate protrusion 1633 may contact the handle plate body 1642a and generate the contact sound.

In an embodiment, when the handle 164 is continuously rotated in the first direction after the contact sound is generated, the contact sound may continue to be generated as the handle 164 rotates by as much as an angle formed by the plurality of plate protrusions 1633 spaced with respect to the rotation axis of the main screw 162. Even when the user does not perceive an initial contact sound, the user may perceive a contact sound that is additionally generated by continuously rotating the handle 164 in the first direction.

Referring to FIG. 4, a section in which threads are not formed may exist in the shaft 1622. The threads of the shaft 1622 may be formed only in a certain section so that the holder 166 moves only between the sections with a position of the holder 166 as a boundary when the link 16 is in the fastened state and released state. When link 16 is in the released state, the holder 166 may be separated from the threads of shaft 1622 and may be supported on the threads of shaft 1622.

For example, even when the link 16 is in the released state, the holder 166 may be firmly engaged with the threads as the handle 164 rotates in the second direction when the holder 166 is connected to the threads. The force by which the holder 166 engages with the threads may be greater than the force by which the handle 164 tends to rotate the main screw 162. In this state, when the handle 164 is rotated in the first direction, only the handle 164 may rotate in the first direction while the main screw 162 is fixed and a contact sound may be generated. Through a structure in which the holder 166 is separated from the threads in the released state, it is possible to prevent or reduce a chance of the handle 164 from spinning in the first direction.

In an embodiment, a motion assistance apparatus may further include a link elastic body 167 provided on a surface of the link body/support 161 facing the holder 166. For example, the link elastic body 167 may be formed of rubber. When the link 16 is in the released state, the link elastic body 167 may be pressed by the holder 166. The link elastic body 167 may press the holder 166 in the direction of the lower frame 15. By rotating the handle 164 in the first direction, the holder 166 separated from the threads may be re-engaged with the threads.

In an embodiment, the link elastic body 167 may be provided as a pair disposed on opposite sides with respect to the rotation axis of the main screw 162. From this disposition, the holder 166 may be pressed while maintaining a state in which the bottom surface of the holder 166 faces the lower frame 15. The holder 166 may be easily engaged with the threads of the shaft 1622 and damage to the threads due to friction may be reduced.

Each embodiment herein may be used in combination with any other embodiment(s) described herein.

In another embodiment, the fastened state of the link 16 may be recognized using a sensor. A magnet may be provided on the bottom surface of the holder 166 and a hall integrated circuit (IC) may be provided on the holder accommodating groove 153 or a cover wrapping around the outer surface of the lower frame 15. The hall IC may detect a distance from the hall IC to a spaced apart magnet and transmit the detected distance to a system. The user may recognize the fastened state through the distance transmitted to the system.

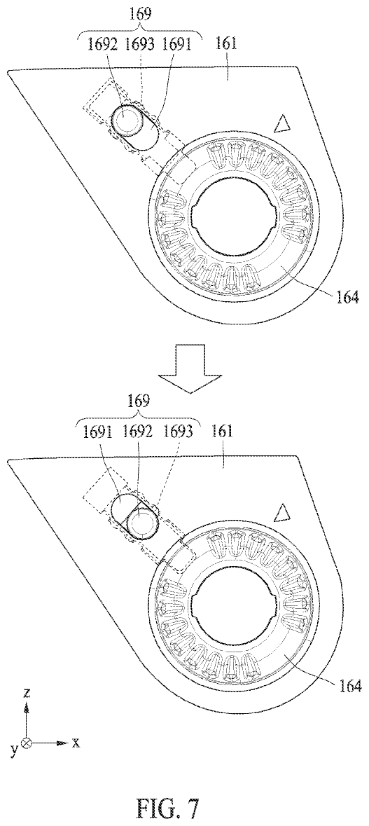

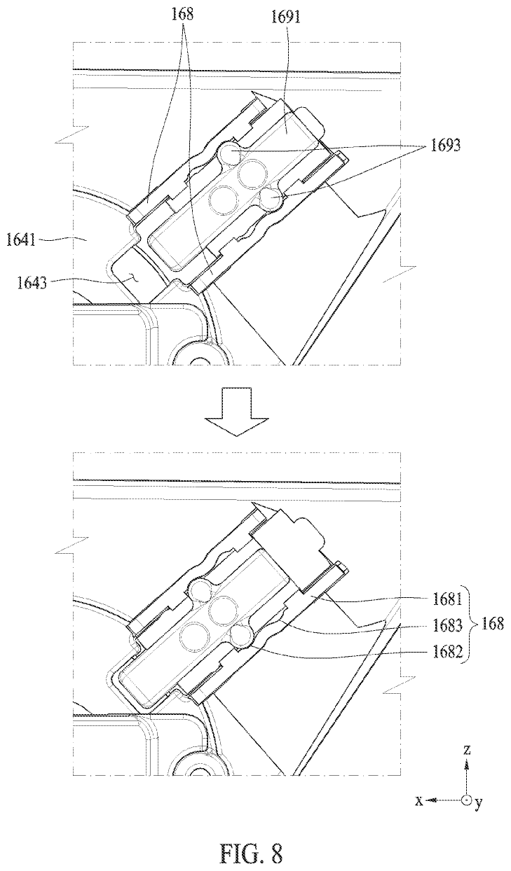

FIG. 7 is a plan view illustrating a link body/support, a locking bar, and a handle according to an embodiment and FIG. 8 is a bottom view illustrating the link body, the locking bar, the handle, and a pair of guide rails according to an embodiment.

Referring to FIGS. 7 and 8, according to an embodiment, a motion assistance apparatus may further include a pair of guide rails 168 and a locking bar 169. The locking bar 169 may slide in one direction along the pair of guide rails 168 provided side by side inside the link body 161. When a link 16 is in the fastened state, the locking bar 169 may slide in one direction and a part of the locking bar 169 may be accommodated inside the handle 164. Since the handle 164 is caught on the locking bar 169, rotation of the handle 164 in the first direction and in the second direction may be restricted. In the fastened state, it is possible to prevent or reduce a chance of the handle 164 from rotating due to unintended external force. The fastened state of the link may be maintained. The locking bar 169 may include a bar body 1691, a bar handle 1692, and a bar protrusion 1693.

In an embodiment, the bar body 1691 may be provided to be slidable in one direction in the link body/support 161. The bar handle 1692 may protrude from the bar body 1691 towards the outside of the link body 161. As the bar handle 1692 moves in one direction, the locking bar 169 may slide along with the bar handle 1692 in the same direction.

In an embodiment, the bar body 1691 may slide toward the handle 164 and an end of the bar body 1691 may be accommodated in a bar accommodating groove 1643 formed in the handle cover 1641. For example, the bar accommodating groove 1643 may be formed in plurality along the circumference of the rotation axis around the rotation axis of the handle 164.

In an embodiment, the bar protrusion 1693 may be provided as a pair protruding from both sides of the bar body 1691, respectively. The pair of bar protrusions 1693 may be accommodated in grooves formed in the pair of guide rails 168, respectively.

In an embodiment, the guide rail 168 may include a side rail 1681 supporting both sides of the bar body 1691 and two grooves recessed in the side rail 1681. Here, one of the two grooves is a groove 1682 (which may be referred to as a “first guide groove”) that accommodates the bar protrusion 1693 in a state in which the end of the bar body 1691 is accommodated in the bar accommodating groove 1643 and the other groove is a groove 1683 (which may be referred to as a “second guide groove”) that accommodates the bar protrusion 1693 in a state in which the end of the bar body 1691 is not accommodated in the bar accommodating groove 1643.

In an embodiment, the pair of guide rails 168 may include sections protruding in directions facing each other between the first guide groove 1682 and the second guide groove 1683, respectively. From this structure, the bar protrusion 1693 may require a certain amount of force to slide from the first guide groove 1682 to the second guide groove 1683 or from the second guide groove 1683 to the first guide groove 1682 along the guide rail 168. It is possible to prevent or reduce a chance of the bar handle 1692 from being easily moved by external force.

In an embodiment, the bar accommodating groove 1643 may be hidden by the link body/support 161 and not visible from outside. On an outer surface of the handle cover 1641 overlapping with the bar accommodating groove 1643 based on a direction of the rotation axis of the handle 164, there may be marks such as a smooth surface, protrusion, groove, pattern, etc., by which the user may recognize the location of the bar accommodating groove 1643. After rotating the handle 164 so that corresponding marks are in line with the sliding direction of the locking bar 169, the end of the bar body 1691 may be in the bar accommodating groove 1643 by moving the bar handle 1692.

According to an embodiment, a motion assistance apparatus including a link having a fastening notification function may include a waist frame and a waist belt worn around the waist of a user, a force transmission frame and a thigh belt worn around the thigh of the user, an actuator connected to the waist frame and configured to generate power, an upper frame connected to the actuator, a lower frame connected to the upper frame and configured to transmit the generated power to the force transmission frame, and the link connecting the upper frame and the lower frame. The link may include a link body disposed on, directly or indirectly, the lower frame, a screw connected to the link body to be rotatable, an ascending and descending plate including a plate body rotatable with the screw and a plate protrusion protruding from the plate body and provided to be movable along an axial direction of the screw, a handle connected to the screw to be rotatable and configured to transmit power to the ascending and descending plate, an inner elastic body, comprising elastic material, provided between at least the screw and the plate body, and a holder connected to the screw to be rotatable, provided to be movable along the axial direction of the screw, and provided on an opposite side of the handle based on the link body. The plate protrusion receives an elastic force from the inner elastic body and moves along the axial direction of the screw to contact with the handle when the handle rotates with respect to the plate body in a state in which the holder is in contact with the lower frame.

According to an example embodiment, a motion assistance apparatus including a link having a fastening notification function may include a waist frame and a waist belt worn around a waist of a user, a force transmission frame and a thigh belt worn around a thigh of the user, an actuator connected to the waist frame and configured to generate power, an upper frame connected to the actuator, a lower frame connected to the upper frame and configured to transmit the generated power can be used by the force transmission frame, and the link connecting the upper frame to at least the lower frame. The link may include a link body disposed on the lower frame, a main screw comprises a screw body supported by the link body and connected to the link body to be rotatable, an inner elastic body supported by the screw body, an ascending and descending plate supported by the inner elastic body and configured to be rotatable with the main screw and to be movable along an axial direction of the main screw, a handle, comprising a handle plate body facing the ascending and descending plate and a handle protrusion protruding from the handle plate body towards the ascending and descending plate, and connected the main screw and configured to be rotatable and to transmit power to the ascending and descending plate, and a holder connected to the main screw and configured to be rotatable and to be movable in the axial direction of the main screw. The ascending and descending plate receives an elastic force from the inner elastic body and moves along the axial direction of the main screw to contact with the handle protrusion when the handle rotates with respect to the ascending and descending plate in a state in which the holder is in contact with the lower frame.

In an embodiment, a contact sound may be generated when the ascending and descending plate with the elastic force received from the inner elastic body moves in the axial direction of the main screw and contacts the handle protrusion.

In an embodiment, in a state where the holder is spaced apart from the lower frame, power transmitted from the handle to the ascending and descending plate may simultaneously rotate the main screw and the ascending and descending plate.

In an embodiment, in a state in which the holder is in contact with the lower frame, the power transmitted from the handle to the ascending and descending plate may move the ascending and descending plate based on the axial direction of the main screw.

In an embodiment, the ascending and descending plate may include a plate body in contact with the inner elastic body, and a plate protrusion protruding from the plate body towards the handle plate body.

In an embodiment, the plate body of the ascending and descending plate with the elastic force received from the inner elastic body may contact with the handle protrusion when the handle rotates with respect to the ascending and descending plate in a state in which the holder is in contact with the lower frame.

In an embodiment, the plate protrusion may include an inclined surface in which a height protruding from the plate body increases.

In an embodiment, in a state in which the holder is in contact with the lower frame, the handle protrusion may slide along the inclined surface of the plate protrusion.

In an embodiment, while the handle protrusion slides along the inclined surface of the plate protrusion, a distance between the ascending and descending plate and the main screw may decrease.

In an embodiment, a link elastic body provided on a surface of the link body facing the holder and compressed by the holder may be further included.

In an embodiment, the link elastic body may be provided as a pair disposed opposite to each other with respect to the rotation axis of the main screw.

In an embodiment, when the link elastic body is compressed by the holder, the holder may be separated from threads of the main screw.

In an embodiment, a pair of guide rails provided side by side inside the link body and a locking bar sliding in one direction along the pair of guide rails and configured to accommodate at least a part of the handle may be further included.

In an embodiment, the pair of guide rails may include sections protruding in directions facing each other.

In an embodiment, the main screw may further include a shaft fixed to the screw body and having threads that can be connected to the holder.

In an example embodiment, a wearable motion assistance apparatus may comprises a link having at least a fastening notification function, the wearable motion assistance apparatus comprising: a waist frame and a waist belt configured to be worn proximate a waist of a user; a force transmission frame and a thigh belt configured to be worn around a thigh of the user; an actuator, comprising a motor, connected to at least the waist frame and configured to generate power; an upper frame; a lower frame; and the link connecting the upper frame to at least the lower frame, wherein the link comprises: a link support disposed on the lower frame; a main screw connected to the link support to be rotatable; an ascending and descending plate configured to be rotatable with the main screw and to be movable in an axial direction of the main screw; a handle, comprising a handle plate body facing the ascending and descending plate and a handle protrusion protruding from the handle plate body towards the ascending and descending plate, and connected the main screw and configured to be rotatable; an inner elastic body, comprising elastic material, supporting the ascending and descending plate; and a holder connected to the main screw and configured to be rotatable, the holder configured to be movable in the axial direction of the main screw, and provided on an opposite side of the handle based on the link support, wherein the ascending and descending plate is configured to receive an elastic force from the inner elastic body and to move in the axial direction of the main screw to contact with the handle protrusion when the handle rotates with respect to the ascending and descending plate.

In an example embodiment, a wearable motion assistance apparatus may comprise a link having at least a fastening notification function, where the wearable motion assistance apparatus may comprise: a waist frame and a waist belt configured to be worn proximate a waist of a user; a force transmission frame and a thigh belt configured to be worn around a thigh of the user; an actuator, comprising a motor, connected to at least the waist frame and configured to generate power; an upper frame; a lower frame; and the link connecting the upper frame to at least the lower frame, wherein the link comprises: a link support disposed on the lower frame; a main screw connected to the link support to be rotatable; a plate body configured to be rotatable with the screw and a plate protrusion protruding from the plate body, and configured to be movable in an axial direction of the main screw; a handle connected to the main screw and configured to be rotatable; an inner elastic body, comprising elastic material, supporting the plate body; and a holder connected to the main screw and configured to be rotatable, the holder configured to be movable in the axial direction of the main screw, and provided on an opposite side of the handle based on the link support, wherein the plate protrusion is configured to receive an elastic force from the inner elastic body and to move in the axial direction of the main screw to contact with the handle when the handle rotates with respect to the plate body.

In an embodiment, the features of embodiments described above may be combined.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and equivalents to the claims are also within the scope of the following claims.

What is claimed is:

1. A wearable motion assistance apparatus comprising a link having at least a fastening notification function, the wearable motion assistance apparatus comprising:
a waist frame and a waist belt configured to be worn proximate a waist of a user;
a force transmission frame and a thigh belt configured to be worn around a thigh of the user;
an actuator, comprising a motor, connected to the waist frame and configured to generate power;
an upper frame connected to the actuator;
a lower frame connected to the upper frame and configured so that the generated power can be used by the force transmission frame; and
the link connecting the upper frame to at least the lower frame,
wherein the link comprises:
a link body disposed on the lower frame;
a main screw comprises a screw body supported by the link body and connected to the link body to be rotatable;
an inner elastic body, comprising elastic material, supported by the screw body;
an ascending and descending plate supported by the inner elastic body and configured to be rotatable with the main screw and to be movable in an axial direction of the main screw;
a handle, comprising a handle plate body facing the ascending and descending plate and a handle protrusion protruding from the handle plate body towards the ascending and descending plate, and connected the main screw and configured to be rotatable and to transmit power to the ascending and descending plate; and
a holder connected to the main screw and configured to be rotatable and to be movable in the axial direction of the main screw,
wherein the ascending and descending plate is configured to receive an elastic force from the inner elastic body and to move in the axial direction of the main screw to contact with the handle protrusion when the handle rotates with respect to the ascending and descending plate in a state in which the holder is in contact with the lower frame.

2. The motion assistance apparatus of claim 1, wherein the ascending and descending plate and the handle protrusion are configured to generate a contact sound when the ascending and descending plate with the elastic force received from the inner elastic body moves in the axial direction of the main screw and contacts the handle protrusion.

3. The motion assistance apparatus of claim 1, wherein the ascending and descending plate, the main screw, and the handle are configured so that power transmitted from the handle to the ascending and descending plate is configured to simultaneously rotate the main screw and the ascending and descending plate in a state in which the holder is spaced apart from the lower frame.

4. The motion assistance apparatus of claim 1, wherein the ascending and descending plate, the main screw, and the handle are configured so that power transmitted from the handle to the ascending and descending plate is configured to move the ascending and descending plate based on the axial direction of the main screw in a state in which the holder is in contact with the lower frame.

5. The motion assistance apparatus of claim 1, wherein the ascending and descending plate comprises:
a plate body in contact with the inner elastic body; and
a plate protrusion protruding from the plate body towards the handle plate body.

6. The motion assistance apparatus of claim 5, wherein the plate body of the ascending and descending plate with the elastic force received from the inner elastic body contacts with the handle protrusion when the handle rotates with respect to the ascending and descending plate in a state in which the holder is in contact with the lower frame.

7. The motion assistance apparatus of claim 5, wherein the plate protrusion comprises an inclined surface in which a height protruding from the plate body increases.

8. The motion assistance apparatus of claim 7, wherein the handle protrusion is configured to be slidable along the inclined surface of the plate protrusion in a state in which the holder is in contact with the lower frame.

9. The motion assistance apparatus of claim 8, wherein the inclined surface is configured so that a distance between the plate body and the main screw decreases while the handle protrusion slides along the inclined surface of the plate protrusion.

10. The motion assistance apparatus of claim 1, further comprising:
a link elastic body provided on a surface of the link body facing the holder and configured to be compressed by the holder.

11. The motion assistance apparatus of claim 10, wherein the link elastic body is provided in a pair disposed opposite to each other with respect to a rotation axis of the main screw.

12. The motion assistance apparatus of claim 11, wherein the holder is configured to be separated from threads of the main screw when the link elastic body is compressed by the holder.

13. The motion assistance apparatus of claim 1, further comprising:
a pair of guide rails provided side by side inside the link body; and
a locking bar configured to slide in one direction along the pair of guide rails, so that at least a part of the locking bar is accommodated in the handle.

14. The motion assistance apparatus of claim 13, wherein the pair of guide rails comprises sections having shapes protruding in directions facing each other.

15. A wearable motion assistance apparatus comprising a link having at least a fastening notification function, the wearable motion assistance apparatus comprising:
a waist frame and a waist belt configured to be worn proximate a waist of a user;
a force transmission frame and a thigh belt configured to be worn around a thigh of the user;
an actuator, comprising a motor, connected to the waist frame and configured to generate power;
an upper frame connected to the actuator;
a lower frame connected to the upper frame and configured so that the generated power can be used by the force transmission frame; and
the link connecting the upper frame to at least the lower frame,
wherein the link comprises:
a link body disposed on the lower frame;
a main screw connected to the link body to be rotatable;
an ascending and descending plate, comprising a plate body, configured to be rotatable with the main screw and a plate protrusion protruding from the plate body and configured to be movable in an axial direction of the main screw;
a handle connected to the main screw and configured to be rotatable and to transmit power to the ascending and descending plate;
an inner elastic body, comprising elastic material, provided between at least the main screw and the plate body; and
a holder connected to the main screw and configured to be rotatable, the holder configured to be movable in the axial direction of the main screw, and provided on an opposite side of the handle based on the link body,
wherein the plate protrusion is configured to receive an elastic force from the inner elastic body and to move in the axial direction of the main screw to contact with the handle when the handle rotates with respect to the plate body in a state in which the holder is in contact with the lower frame.

16. The motion assistance apparatus of claim 15, wherein the plate protrusion and the handle are configured to generate a contact sound when the ascending and descending plate with the elastic force received from the inner elastic body moves in the axial direction of the main screw and contacts the handle.

17. The motion assistance apparatus of claim 15, wherein the ascending and descending plate, the main screw, and the handle are configured so that power transmitted from the handle to the ascending and descending plate is configured to simultaneously rotate the main screw and the ascending and descending plate in a state in which the holder is spaced apart from the lower frame.

18. The motion assistance apparatus of claim 1, wherein the ascending and descending plate, the main screw, and the handle are configured so that power transmitted from the handle to the ascending and descending plate is configured to move the ascending and descending plate based on the axial direction of the main screw in a state in which the holder is in contact with the lower frame.

19. A wearable motion assistance apparatus comprising a link having at least a fastening notification function, the wearable motion assistance apparatus comprising:
a waist frame and a waist belt configured to be worn proximate a waist of a user;
a force transmission frame and a thigh belt configured to be worn around a thigh of the user;
an actuator, comprising a motor, connected to at least the waist frame and configured to generate power;
an upper frame;
a lower frame; and
the link connecting the upper frame to at least the lower frame,
wherein the link comprises:
a link support disposed on the lower frame;
a main screw connected to the link support to be rotatable;
an ascending and descending plate configured to be rotatable with the main screw and to be movable in an axial direction of the main screw;
a handle, comprising a handle plate body facing the ascending and descending plate and a handle protrusion protruding from the handle plate body towards the ascending and descending plate, and connected the main screw and configured to be rotatable;
an inner elastic body, comprising elastic material, supporting the ascending and descending plate; and
a holder connected to the main screw and configured to be rotatable, the holder configured to be movable in the axial direction of the main screw, and provided on an opposite side of the handle based on the link support,
wherein the ascending and descending plate is configured to receive an elastic force from the inner elastic body and to move in the axial direction of the main screw to contact with the handle protrusion when the handle rotates with respect to the ascending and descending plate.

20. A wearable motion assistance apparatus comprising a link having at least a fastening notification function, the wearable motion assistance apparatus comprising:
a waist frame and a waist belt configured to be worn proximate a waist of a user;
a force transmission frame and a thigh belt configured to be worn around a thigh of the user;
an actuator, comprising a motor, connected to at least the waist frame and configured to generate power;
an upper frame;
a lower frame; and
the link connecting the upper frame to at least the lower frame,
wherein the link comprises:
a link support disposed on the lower frame;
a main screw connected to the link support to be rotatable;
a plate body configured to be rotatable with the screw and a plate protrusion protruding from the plate body, and configured to be movable in an axial direction of the main screw;
a handle connected to the main screw and configured to be rotatable;
an inner elastic body, comprising elastic material, supporting the plate body; and
a holder connected to the main screw and configured to be rotatable, the holder configured to be movable in the axial direction of the main screw, and provided on an opposite side of the handle based on the link support,
wherein the plate protrusion is configured to receive an elastic force from the inner elastic body and to move in the axial direction of the main screw to contact with the handle when the handle rotates with respect to the plate body.
